(19) United States
(12) Patent Application Publication
(10) Pub. No.: US 2009/0279024 A1
(43) Pub. Date: Nov. 12, 2009

(54) PROTECTION OF A CHOLESTERIC LIQUID CRYSTAL DISPLAY DEVICE

(76) Inventors: David Coates, Wimbourne (GB); Anthony Orlando Alkins, Littlemore (GB); Andrew David Pearson, Crawley (GB)

Correspondence Address: Pearl Cohen Zedek Latzer, LLP, 1500 Broadway, 12th Floor, New York, NY, 10036, US

(21) Appl. No.: 12/304,308

(22) PCT Filed: May 17, 2007
(86) PCT No.: PCT/GB07/01819

§ 371 Date: Dec. 11, 2008

(30) Foreign Application Priority Data
Jun. 15, 2006 (GB) 0611895.4

(51) Int. Cl. G02F 1/1335

(52) U.S. Cl. 349/104; 349/137

(57) ABSTRACT

A cholesteric liquid crystal display device (24) has a protective sheet (40) or a stack of protective sheets adhered to the substrate (11) at the front of a stack of cells (10B, 10G, 10R) containing cholesteric liquid crystal material (19). The protective sheet is adhered by a layer of adhesive (40) which is either an adhesive curable by heat or an adhesive curable by light. The adhesive contains a UV blocking agent, for example, a compound based on benzophenone, having a property of reducing the transmission of ultra-violet light through the adhesive. The protective sheet (s) provides protection to the display device and may be made of glass or plastic. Adhering the protective sheet (s) with an adhesive provides the advantages of being much cheaper to implement than laminated glass and of allowing the adhesive to contain the UV blocking agent for UV protection of the cholesteric liquid crystal material.

The present invention relates to a cholesteric liquid crystal display device and in particular to providing protection thereof.

A cholesteric liquid crystal display device is a type of reflective display device having a low power consumption and a high brightness. This makes the device particularly useful for use in bright ambient light such as outdoors.

A cholesteric liquid crystal display device typically uses one or more cells each having a layer of cholesteric liquid crystal material contained between two substrates. The cholesteric liquid crystal material is capable of being switched between a plurality of states in which it either reflects light with wavelengths in a band corresponding to a predetermined colour or transmits light. A full colour display may be achieved by stacking layers of cholesteric liquid crystal material capable of reflecting different coloured light.

The thickness of the substrates in the cells is limited by the manufacturing process of the cells. This makes the device fragile. It is therefore desirable to provide protection which reduces the chance of damage to the substrates which can occur in normal use, for example during handling of the display device or in the event of an impact. The invention is directed to the provision of such physical protection.

Existing liquid crystal display devices employing other types of liquid crystal for example twisted nematic (TN) and intended for use outdoors or in public areas are often provided with a protective sheet which is mounted in front of the device. The purpose is to protect the display device from mechanical shock which could potentially damage the substrates which form part of the structure of the display device and which are fragile due to being thin. The protective sheet is usually a laminated glass sheet comprising two or more sheets of glass bonded together using a thermoplastic resin such as polyvinyl butyral (PVB) that melts when heated. This laminate is then mounted in front of the device, for example clipped into a housing of the device. The present inventors have considered applying this measure to a cholesteric liquid crystal device, but the problem with this is the high cost of laminated glass which is required to be thin (with a thickness of less than 1 mm, say). The high cost arises because the manufacturing process is complicated.

A subsidiary issue is that exposure to ultra-violet (UV) light can damage the liquid crystal material and ultimately prevent proper operation to display an image. It is therefore desirable to reduce the transmission of UV light to the liquid crystal material. A preferred feature of the invention is directed to providing such UV protection.

Many existing liquid crystal display devices employing other types of liquid crystal for example twisted nematic (TN) have a film polariser disposed in front of the liquid crystal as part of the optical system allowing display of an image. Such a film polariser can be made of or incorporate a material which contains a UV blocking agent provides protection of the liquid crystal from UV light. In a cholesteric liquid crystal device, such a film polariser is not used, so this option for UV protection is not available.

The present inventors have considered the use of an anti-reflective or anti-glare film made of a material containing a W blocking agent. However, such films laminated onto the display device have limited life before they peel away or become damaged physically, particularly where the display device is used outdoors and therefore exposed to the weather.

According to the present invention, there is provided a cholesteric liquid crystal display device, comprising:

at least one cell comprising two substrates containing therebetween a layer of cholesteric liquid crystal material; and

a protective sheet or a stack of plural protective sheets, being adhered to the substrate at the front of the at least one cell by a layer of adhesive and, in the case of a stack of plural protective sheets, being adhered to each other by a layer of adhesive between each pair of adjacent protective sheets in the stack,

wherein

the adhesive is either an adhesive curable by heat or an adhesive curable by light, and

the adhesive contains a UV blocking agent having a property of reducing the transmission of ultra-violet light through the adhesive.

The protective sheet provides physical protection against damage to the substrates of the cell(s) of the cholesteric liquid crystal display device which may occur in normal use, for example when the display device is handled or receives impacts in situ. By adhering the protective sheet(s) to the display device, and in the case of a stack of protective sheets to each other, by adhesive which is either an adhesive curable by heat or an adhesive curable by light, the manufacturing process is straightforward. This is because adhesive curable by heat or by light is relatively simple to use. The implementation of protection is therefore of low cost as compared to the use of laminated glass in which sheets are bonded together using a thermoplastic resin such as polyvinyl butyral (PVB) that melts when heated. In addition, the UV blocking agent provides UV protection of the cholesteric liquid crystal material which therefore prolongs the life of the liquid crystal material. It is straightforward to incorporate the UV blocking agent into the adhesive, because this basically involves just dissolving of the UV blocking agent prior to use. Thus, the protective sheet(s) adhered by adhesive to the display device not only provides physical protection but also UV protection in a very versatile and cost-effective manner.

The protective sheet(s) may conveniently be made of glass which is particularly hard and robust, but may equally be made of other materials such as plastic.

To allow better understanding, an embodiment of the present invention will now be described by way of non-limitative example with reference to the accompanying drawings, in which:

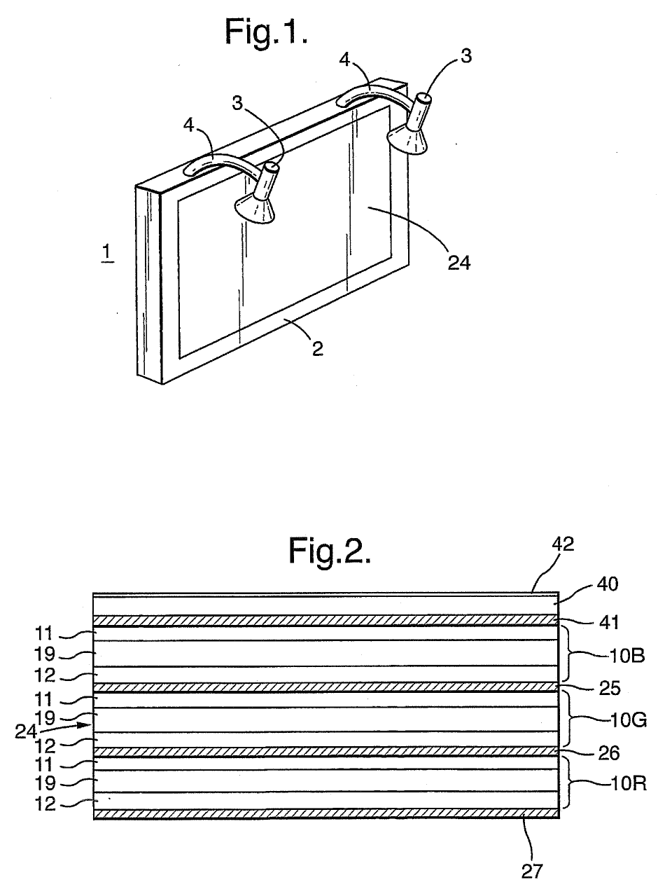

FIG. 1 is a perspective view of a cholesteric liquid crystal display device;

FIG. 2 is a cross-sectional view of the cholesteric liquid crystal display device;

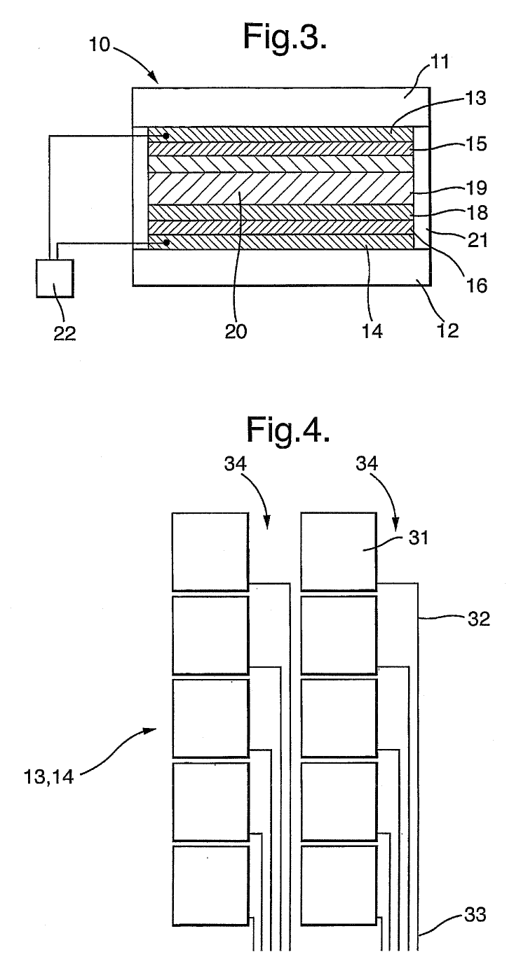

FIG. 3 is a cross-sectional view of a cell of a cholesteric liquid crystal display device;

FIG. 4 is a plan view of the electrode arrangement of a conductive layer of the cell of FIG. 3;

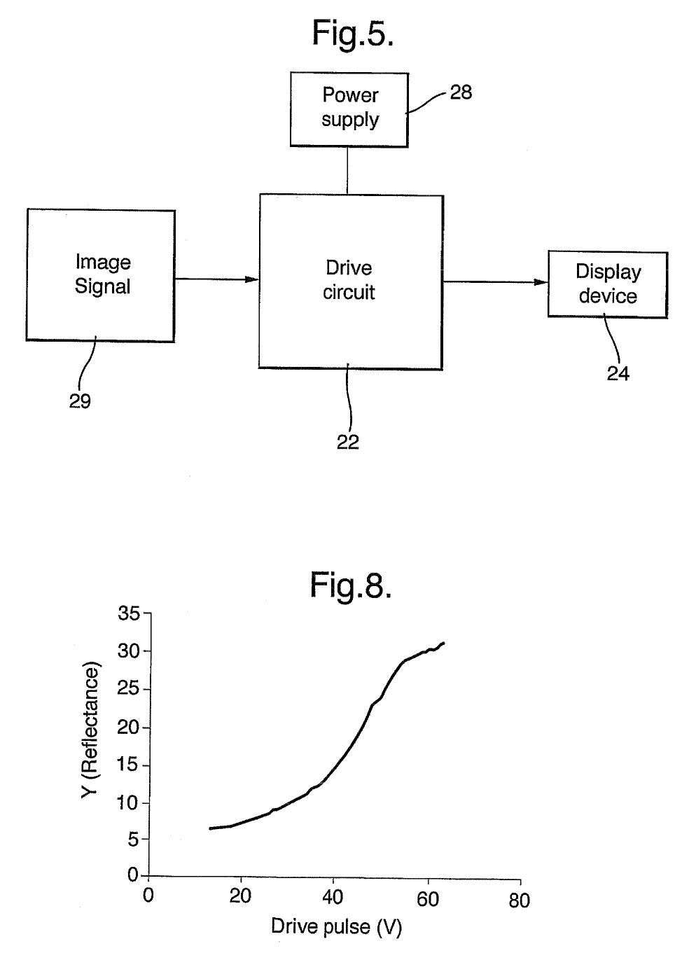

FIG. 5 is a diagram of the control circuit of the display device;

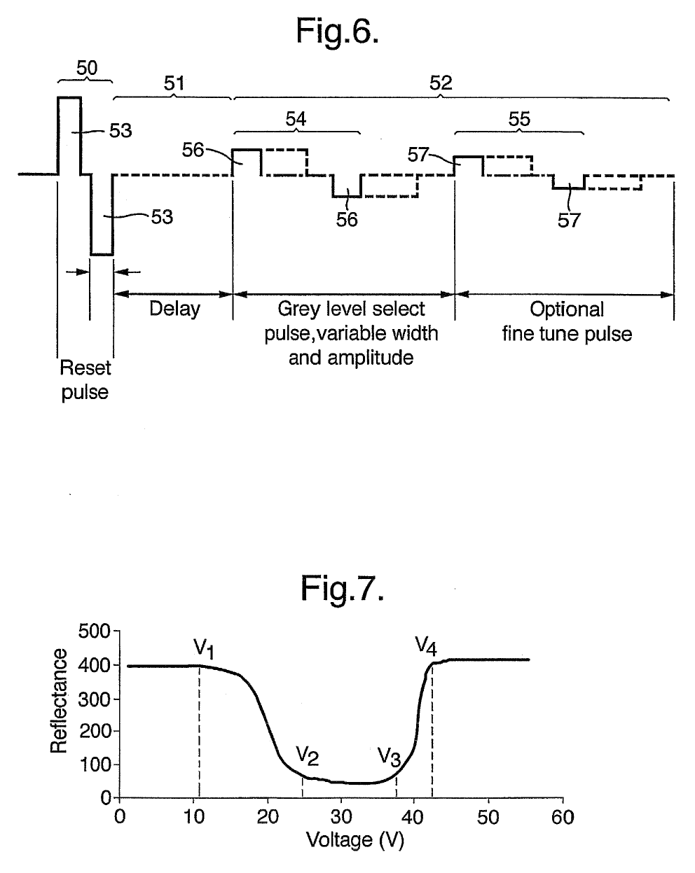

FIG. 6 is a graph of a drive signal in accordance with a static drive scheme;

FIG. 7 is a graph of the electro-optical curve of a typical liquid crystal material;

FIG. 8 is a graph of reflectance of the pixel against amplitude of a selection pulse with the drive signal of FIG. 6;

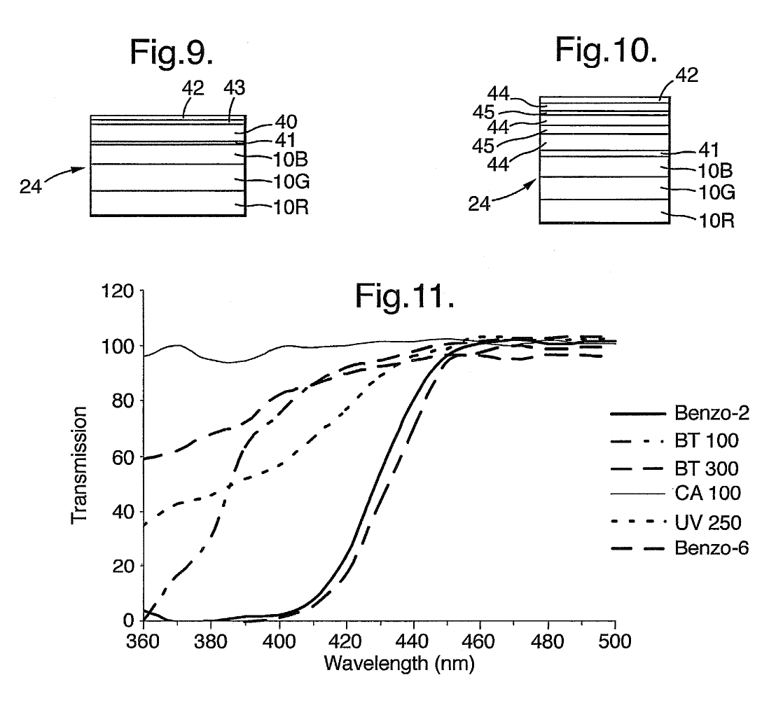

FIG. 9 is a cross-sectional view of a cholesteric liquid crystal display device of modified form;

FIG. 10 is a cross-sectional view of another cholesteric liquid crystal display device of modified form;

FIG. 11 is a graph of the absorption spectra of different UV blocking agents in an adhesive Epotek 310; and

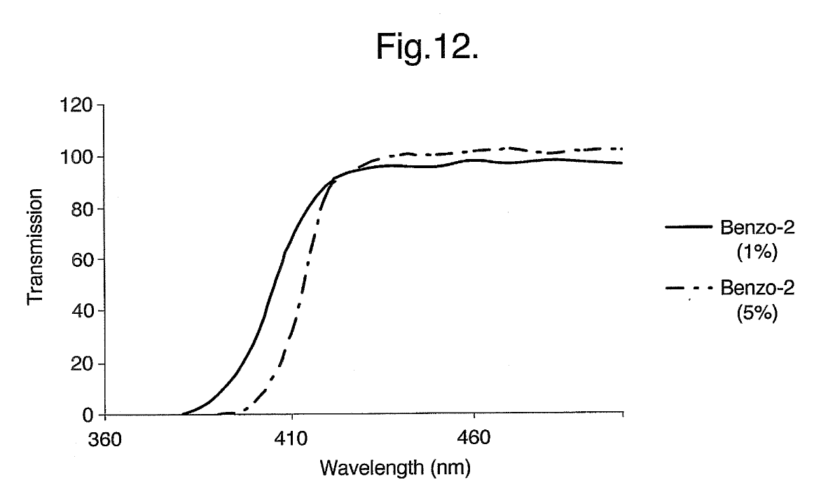

FIG. 12 is a graph of the absorption spectra of a UV blocking agent at two different concentrations in an adhesive Slink 833.

As shown in FIG. 1, a display apparatus 1 comprises a cholesteric liquid crystal display device 24 mounted in a frame 2. A pair of lights 3 are supported on the frame 2 by respective arms 4. The lights 3 are directed to illuminate the display device 24 when the lights 3 are on. Power may be supplied to operate the lights 3 in response to a light sensor detecting that the ambient light has fallen below a predetermined threshold and/or in response to a timer indicating that it is night-time.

The cholesteric liquid crystal display device 24 will first be described in detail.

As shown in FIG. 2, the cholesteric liquid crystal display device 24 comprises three cells 10R, 10G, 10B each of which has the same construction. A single cell 10 is illustrated in detail in FIG. 3, whereas in FIG. 2, some of the layers of the cells 10R, 10G, 10B are omitted for clarity.

The cell 10 has a layered construction, the thickness of the individual layers 11-19 being exaggerated in FIG. 3 for clarity.

The cell 10 comprises two rigid substrates 11 and 12, which may be made of glass or plastic. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of addressable pixels, as described in more detail below.

Optionally, both conductive layers 13 and 14 are overcoated with a respective insulation layer 15 and 16, for example of silicon dioxide, or possibly plural insulation layers.

The substrates 11 and 12 define between them a cavity 20, typically having a thickness of 3 μm to 10 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyimide which may optionally be unidirectionally rubbed. Thus, the liquid crystal layer 19 is surface-stabilised, although it could alternatively be bulk-stabilised, for example using a polymer or a silica particle matrix.

The liquid crystal layer 19 comprises cholesteric liquid crystal material. Such material has several states in which the reflectivity and transmissivity vary. These states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 19 selectively reflects a bandwidth of light that is incident upon it. The reflectance spectrum of the liquid crystal layer 19 in the planar state typically has a central band of wavelengths in which the reflectance of light is substantially constant.

The wavelength λ of the reflected light are given by Bragg's law, ie λ=nP, where n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The planar state is used as the bright state of the liquid crystal layer 19.

Not all the incident light is reflected in the planar state. In a typical full colour display device 24 employing three cells 10, as described further below, the peak reflectivity is typically of the order of 40-45%. The light not reflected by the liquid crystal layer 19 is transmitted through the liquid crystal layer 19. The transmitted light is subsequently absorbed by a black layer 27 described in more detail below.

In the focal conic state, the liquid crystal layer 19 is, relative to the planar state, transmissive and transmits incident light. Strictly speaking, the liquid crystal layer 19 is mildly light scattering with a small reflectance, typically of the order of 3-4%. As light transmitted through the liquid crystal layer is absorbed by the black layer 27 described in more detail below, this state is perceived as darker than the planar state. Thus the focal conic state may be used as the dark state.

In the homeotropic state, the liquid crystal layer 19 is even more transmissive than in the focal conic state, typically having a reflectance of the order of 0.5-0.75%. Use of the homeotropic state as the dark state has the advantage of increasing the contrast ratio, as compared to use of the focal conic state as the dark state.

The display apparatus 1 has a drive circuit 22 mounted inside the housing 2. The drive circuit 22 supplies a drive signal to the conductive layers 13 and 14 which consequently apply the drive signal across the liquid crystal layer 19 to switch it between its different states. The drive circuit 22 is described in more detail below, but two general points are to be noted.

Firstly, the focal conic and planar states are stable states which can coexist when no drive signal is applied to the liquid crystal layer 19. Furthermore the liquid crystal layer 19 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies, thus giving a range of grey levels.

Secondly, the homeotropic state is not stable and so maintenance of the homeotropic state requires continued application of a drive signal.

As shown in FIG. 2, the display device 24 comprises the cells 10R, 10G and 10B arranged in a stack. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 2, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Color Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 27 may be formed as a layer of black paint. In use, the black layer 27 absorbs any incident light which is not reflected by the cells 10R, 10G or 10B. Thus when all the cells 10R, 10G or 10B are switched into a transmissive state, the display device appears black.

The display device 24 is similar to the type of device disclosed in WO-01/88688 which is incorporated herein by reference and the teachings of which may be applied to the present invention.

In each cell 10, the conductive layers 13 and 14 are patterned to provide an electrode arrangement which is capable of providing independent driving of a rectangular array of pixels across the liquid crystal layer 19 by different respective drive signals. In particular, the electrode arrangement is provided as follows.

A first one of the conductive layers 13 or 14 (which may be either of the conductive layers 13 or 14) is patterned as shown in FIG. 4 and comprises a rectangular array of separate drive electrodes 31. The other, second one of the conductive layers 13 or 14 extends over the area opposite the entire array of drive electrodes 31 and thus acts as a common electrode.

The first one of the conductive layers 13 or 14 further comprises separate tracks 32 each connected to one of the drive electrodes 31. Each track 32 extends from its respective drive electrode 31 to a position outside the array of drive electrodes 31 where the track forms a terminal 33. The drive circuit 22 makes an electrical connection to each of the terminals 33 and a common connection to the second one of the conductive layers 13 or 14. Through this connection, the drive circuit 22 in use supplies a respective drive signal to each terminal 33 and thus the respective drive signals are supplied via the tracks 32 to the respective drive electrodes 31. In this manner, each drive electrode 31 independently receives its own drive signal and drives the area of the liquid crystal layer 19 adjacent to that drive electrode 31, which area of the liquid crystal layer 19 acts as a pixel. In this manner, an array of pixels is formed in the liquid crystal layer 19 adjacent to the array of drive electrodes 31. As each drive electrode 31 receives a drive signal independently, each of the pixels is directly addressable.

Such direct addressing of each pixel is advantageous for a number of reasons. The electro-optic performance of the liquid crystal is improved as compared to passive multiplexed addressing because each pixel can be addressed independently without affecting or influencing the neighbouring pixels. Also, direct addressing allows compensation of non-uniformity in the parameters of the cell over the area of the display device, for example variation in thickness of the liquid crystal layer due to the manufacturing process, or temperature variation across the display device. Each pixel can be driven with a drive signal adapted, for example by varying parameters such as voltage or pulse time to compensate those variations.

However, other electrode arrangements providing other types of addressing may be used. For example if the stable planar and focal conic states are used, then the electrode arrangement may provide for passive matrix addressing.

To accommodate the tracks 32 in the first one of the conductive layers 13 or 14, the drive electrodes 31 are arranged in lines (extending vertically in FIG. 4) with a gap 34 between each adjacent line of drive electrodes 31. The tracks 32 connected to a single line of drive electrodes 31 all extend along one of the gaps 34. All the tracks 32 from each drive electrode 31 in the line of drive electrodes 31 exit the array of drive electrodes 31 on the same side, that is lowermost in FIG. 4. As a result, all of the terminals 33 are formed on the same side of the display device 24. This has particular advantage when a plurality of identical display devices 24 are tiled to provide a larger image area because it reduces the gap needed between the individual display devices 24.

For clarity FIG. 4 illustrates the drive electrodes 31 and tracks 32 of only two lines of five pixels. The actual display device 24 may comprise any plural number of pixels in each dimension, typically 36 lines of 18 pixels or larger.

The drive circuit 22 will now be described with reference to FIG. 5.

The drive circuit 22 receives power from an AC power supply 28 which is external to the display apparatus 1 and is typically a mains supply or line supply.

The drive circuit 22 also receives an image signal 29 representing an image. In general, the image signal 29 may represent a static image or a video image. Typically the image signal 29 is digital LCD format running on LVDS bus. The drive circuit 22 derives a drive signal for each of the pixels of each of the cells 10R, 10G and 10B in accordance with the image signal 29 to cause the display device 24 to display the image by switching the liquid crystal material of each pixel into a state having an appropriate reflectance.

The drive circuit may use a variety of drive schemes using drive signals of different forms to drive the liquid crystal material of the pixels into different states. The actual drive scheme used is not directly relevant to the present invention.

One possible drive scheme is a static drive scheme in which pixels are driven into a stable state, that is the planar state, the focal conic state or a mixed state having a reflectance between that of the planar and focal conic states. In the static drive scheme, the drive signals may be of a known form for driving cholesteric liquid crystal into a stable state with variable grey levels. This is a variant of the conventional drive scheme described first in W. Gruebel, U. Wolff and H. Kreuger, Molecular Crystals Liquid Crystals, 24, 103, 1973 and later in other documents.

The drive signal takes the form shown in FIG. 6 which is a graph of voltage over time. The drive signal having the waveform shown in FIG. 6 is supplied for each successive image (that is, in the case of the image signal 29 being a video signal, in each successive frame period of the video signal), in accordance with the value of the respective pixel.

The drive signal comprises a reset pulse waveform 50, followed by a relaxation period 51, followed by a selection pulse waveform 52.

The reset pulse waveform 50 is shaped to drive the pixel into the homeotropic state. In this example, the reset pulse waveform 50 consists of a single balanced DC pulse which may equally be considered as two DC pulses 53 of opposite polarity.

The relaxation period 51 causes the pixel to relax into the planar state. The reset pulse waveform releases quickly so that the relaxation is into the planar state, rather than the focal conic state. The planar state forms within a short time period typically 3 ms to 100 ms depending on liquid crystal materials and alignment layers used. Accordingly the relaxation period is longer than this.

The selection pulse waveform 52 drives the pixel into a stable state having the desired reflectance. To achieve the maximum reflectance, the selection pulse waveform 52 is omitted altogether so that the drive signal consists only of the reset pulse waveform 50, followed by the relaxation period 51 to leave the pixel in the planar state. To achieve lower reflectances, the selection pulse waveform 52 comprises an initial pulse 54 optionally followed by a tuning pulse 55. In this example, the initial pulse 54 and the tuning pulse 55 each consist of a single balanced DC pulse. Thus the initial pulse 54 may equally be considered as two DC pulses 56 of opposite polarity and the tuning pulse 55 may equally be considered as two DC pulses 57 of opposite polarity.

The amplitudes of the initial pulse 54 and the tuning pulse 55 are variable to drive the pixel into a stable state having a correspondingly variable reflectance. This may be understood by reference to FIG. 7 which shows the electro-optical curve of a typical liquid crystal material. In particular, FIG. 7 is a graph of the reflectance (in arbitrary units) of a liquid crystal initially in the planar state (that is at the end of the relaxation period 52) after application of a pulse of variable amplitude (that is the initial pulse 54), the reflectance being plotted against the amplitude of that pulse. Thus the amplitude of the initial pulse 54 is selected at a point on the curve of FIG. 7 between V1 and V2 or between V3 and V4 to provide the desired reflectance.

The slope of the curve between V1 and V2 or between V3 and V4 allows many grey level states to be achieved. For example, FIG. 8 is a graph of reflectance (arbitrary units) which may be achieved against the voltages of the initial pulse 54 of the selection pulse waveform for a liquid crystal material having the electro-optical curve of FIG. 7.

The tuning pulse 55 may be omitted so that the selection pulse waveform 52 comprises a single pulse, that is the initial pulse 54. If the tuning pulse 55 is included, the initial pulse 54 drives the pixel into an initial stable state and the tuning pulse 55 drives the pixel into a final stable state. The tuning pulse 55 preferably has a lower amplitude than the initial pulse 54. The advantage of using the tuning pulse 55 is that it can improve the resolution by allowing the pixel to reach a number of different final stable states between the initial stable states. This improves the static image quality.

In some implementations there is always a tuning pulse 55 regardless of the desired reflectance. In other implementations, the tuning pulse 55 is either (1) absent if the desired reflectance is equal to the reflectance of one of the initial stable states or (2) present if the desired reflectance is equal to the reflectance of one of the final stable states.

As an alternative to the amplitude of the selection pulse waveform 52 being variable, the duration of the initial pulse 54 and/or the tuning pulse 55 may be variable, as shown by the dotted lines in FIG. 6, to achieve a variable reflectance. This works in a similar manner to variation of the amplitude.

The actual amplitudes and durations of the reset pulse waveform 50 and the selection pulse waveform 52 vary in dependence on a number of parameters such as the actual liquid crystal material used, the configuration of the cell 10, for example the thickness of the liquid crystal layer, and other parameters such as temperature. As is routine in cholesteric liquid crystal display devices, these amplitudes and durations can be optimised experimentally for any particular display device 24. Typically, the reset pulse waveform 50 might have an amplitude of 50V to 60V and a duration of from 0.6 ms to 100 ms, more usually 50 ms to 100 ms. Typically the initial pulse 54 and/or the tuning pulse 55 might have an amplitude of from 10V to 20V and a duration of from 0.6 ms to 100 ms.

In the above example, the pulses 52, 54 and 55 are all balanced DC pulses. In general any of these pulses 52, 54 and 55 may alternatively be DC pulses or AC pulses. In general it is preferred that the pulses are DC balanced to limit electrolysis of the liquid crystal layer 19 which can degrade its properties over time. Such DC balancing may be achieved by the use of balanced DC pulses, AC pulses or else DC pulses which are of alternating polarity for successive displayed images.

Other drive scheme for driving the pixels into stable states having variable reflectances are possible and may alternatively be applied as the static drive scheme.

As the static drive scheme drives the pixel in question into a stable state, use of the static drive scheme only consumes power to change image displayed. After the drive signal has been applied, the stable state is maintained and so the pixel continues to display the image without consuming power. Thus the power consumption is low.

Another possible drive scheme is a combined static and dynamic drive scheme as disclosed in the copending patent applications International Application No. PCT/GB05/004278 and British Application No. 0610433.5. In this combined static and dynamic drive scheme, the drive circuit 22 generates drive signals in accordance with two different schemes. In a first portion of the range of reflectances of higher reflectance, the drive circuit 22 generates a drive signal in accordance with a static drive scheme. In a second portion of the range of reflectances of lower reflectance than the first portion, the drive circuit 22 generates a drive signal in accordance with a dynamic drive scheme operating on the same principle as the drive scheme disclosed in WO-2004/030335 and making use of the unstable homeotropic state to drive pixels into a state having a lower reflectance than the focal conic state.

On the front of the display device 24 there is provided a protective structure which will now be described.

In the example of FIG. 2, the protective structure comprises a single protective sheet 40 made of glass adhered by a layer of adhesive 41 to the front surface of the display device 24, that is to the front substrate 11 of the blue cell 10B which is at the front of the stack of cells 10R, 10G, 10B.

The protective sheet 40 protects the display device 24 from physical damage, for example an impact by a stone or any other object. The thickness of the protective sheet 40 is sufficient to provide a desired degree protection which may depend on the precise construction of the cells 10 of the display device 24. In general the ruggedness of the display device can be improved by increasing the thickness of the protective sheet 40, increasing the thickness of the layer 41 of adhesive or by changing the construction of the cells 10. All these features can be easily varied. Balanced with this, the thickness of the protective sheet 40 is reduced as far as possible to minimise weight. Typically the protective sheet 40 has a thickness of 2 mm or less, more preferably 1 mm or less.

The front surface of the protective sheet 40 is optionally provided with a surface treatment 42, such as an etching or a coating, chosen to provide any desired optical properties for example an anti-reflection property, an anti-glare property, a UV blocking property or any combination thereof. Suitable surface treatments 42 providing an anti-reflection property or an anti-glare property are available from many manufacturers such as Zytronics (Zytronic Displays Ltd, Patterson Street, Blaydon, Tyne and Wear, NE21 5SG), and Europtec (Europtec, Glass & Polymer Technologies, EuropTec GmbH, Alte Heerstraβe 14, D-38644, Goslar, Germany). A suitable coating providing a UV blocking property is available from Tegla Berliner Glas Group (TEGLA Technische Glas Transformations GmbH & Co. KG Giengener Strasse 16, D-89428 Syrgenstein-Landshausen, Germany and Berliner Glas KGaA Herbert Kubatz GmbH & Co., Waldaiburger Str. 5, D-12347 Berlin, Germany). Other types of treatment 42 are equally possible. The treatment 42 may be provided on the inner or outer surfaces of the protective sheet 40. The surface treatment 42 is optional but does provide useful properties when present.

In this example, the protective sheet 40 is made of glass which may be any type of glass which is transparent and of optical quality. For example, the protective sheet 40 may be made of soda lime glass or borosilicate glass which are generally available from many glass suppliers (such as Corning or Schott). Another option is that the protective sheet 40 may be made of heat-tempered glass which improves the protection given. Glass is a good material for the protective sheet 40 because it is hard and robust.

As an alternative, the protective sheet 40 may be made of other materials than glass. One option is a plastic. Any transparent plastics material of a suitable optical quality may be used. As an example of this, FIG. 9 illustrates a modified form of the display device 24 identical to that of FIG. 2 except that the protective structure comprises a single protective sheet 40 made of plastic. In this case the protective sheet 40 may have an outer coating 43 of a material which is harder than the plastic of the protective sheet. As plastics materials are generally softer and more susceptible to scratching than glass, the outer coating 43 protects the protective sheet 40 against scratches. In this example, the front surface of the protective sheet 40 is effectively the front surface of the outer coating 43, and the surface treatment 42 is provided thereon.

Another alternative for the protective structure is shown in FIG. 10 which illustrates a modified form of the display device 24 identical to that of FIG. 2 except that the protective structure comprises a stack of protective sheets 44. In this example there are three protective sheets 44 but in general there may be any plural number of protective sheets 44. Each pair of adjacent protective sheets 44 in the stack are adhered by a respective layer 45 of adhesive. The protective sheets 45 have the same purpose as the protective sheet 40 shown in FIG. 2 and the comments herein about the protective sheet 40 apply equally to the protective sheets 45.

As described above, there is adhesive in the layer 41 between the protective structure and the cells 10 of the display device and, in the case of FIG. 10, in the layers 45 between the protective sheets 44. In both cases, the adhesive used is either an adhesive curable by heat or an adhesive curable by light. As such adhesives are relatively simple to use, the protective structure is straightforward to implement with the result that the manufacturing cost is low, particularly as compared to the manufacturing cost of laminated glass in which thin glass sheets are bonded together using a thermoplastic resin such as polyvinyl butyral (PVB) that melts when heated, this being a difficult and costly process.

A wide range of materials can be used as the adhesive of the layers 41 and 45. The adhesive is transparent but there are many suitable optical adhesives available on the market. Some non-limitative examples are as follows.

Where the adhesive of the layers 41 and 45 is curable by heat, it may be a one part or two part adhesive, suitable adhesives two part adhesives being for example those made by Epotek (eg Epotek 310), Promatech Ltd. (of 2 Wilkinson Road, Cirencester, Gloucestershire, GL7 1YT) or Loctite. These two part adhesives have low values of Tg (glass transition temperature). They also give some flexibility to the layers 41 and 45 which improves the protective properties by helping to absorb impacts and which also allows variation in the size of the layers 41 and 45 and the substrate 11 of the blue cell 10B by accommodating thermal expansion differences. Usually some heat is applied to effect full cure.

Where the adhesive of the layers 41 and 45 is curable by light it may be curable by UV light or by visible light.

Many light-cured adhesives are cured by UV light typically of wavelength around, say, 354 nm. Such adhesives are in general usable but care must be taken to control the dose of UV light provided for curing so as not to damage the cholesteric liquid crystal material of the liquid crystal layers 19 of the cells 10R, 10G, 110B.

To reduce the chance of damage to the cholesteric liquid crystal material of the liquid crystal layers 19, one may select an adhesive which is curable by light having a greater wavelength, possibly into the visible part of the spectrum. For example the adhesive may be curable by light having a wavelength of at least 390 nm. Where the adhesive contains a UV blocking agent (as discussed below) the light used to cure the adhesive is preferably at a wavelength for which the UV blocking agent is at least partially transmissive. This depends on the choice of UV blocking agent but typically the adhesive should be curable by light having a wavelength of at most 430 nm

Many suitable adhesives curable by light are available on the market for example, from: Loctite Corporation USA (eg Loctite 3552 visible light cure adhesive); Shanguan Technical Adhesives Co Ltd, Taiwan (eg Slink 2395 and Slink 833 UV/visible cure adhesive); or My Adhesives, Rehovot, Israel (eg MY-133). These adhesives may be cured using either mercury lamps, desirably with filters to reduce the UV energy so it does not damage the cholesteric liquid crystal material of the liquid crystal layers 19, or with fluorescent tubes such as black light lamps.

The adhesive of the layers 41 and 45 contains a UV blocking agent having a property of reducing the transmission of ultra-violet light through the adhesive. In this manner, the protective structure also provides UV protection in that it reduces the amount of UV light which is incident on the cholesteric liquid crystal material of the liquid crystal layers 19. This reduces the degradation of the cholesteric liquid crystal material of the liquid crystal layers 19 and therefore increases the life of the display apparatus 24. The UV blocking agent may be incorporated simply by dissolving it in the adhesive thus providing a simple and cheap manufacturing process. This means that the form of the protective structure as a protective sheet 40 adhered by the layer 41 of adhesive, or a stack of protective sheets 40 adhered by the layers 41 and 45 of adhesive, provides the additional and important advantage of allowing the provision of cheap and effective UV protection by incorporation of the UV blocking agent.

The UV blocking agent can be any of a wide range of commercially available materials. Some non-limitative examples of suitable UV blocking agents are: UW Absorber 325 (available from LANXESS Ltd, Functional Chemicals, West Point, 46-48 West Street, Newbury, RG14 1BD); benzophenone-2 or benzophenone-6 (available from A & E Connock (Perfumery & Cosmetics) Ltd, Alderholt Mill House, Fordingbridge, Hampshire, SP6 1PU; Ciba Geigy Tinosorb (available from Ciba Speciality Chemicals plc, Coating Effects Division, Ciba Speciality Chemicals plc, Charter Way, Macclesfield, Cheshire, SK10 2NX); Optisol (available from Oxonica plc, 7 Begbroke, Science Park, Sandy Lane, Yarnton, Kidlington, Oxfordshire); or benzophenone-3 (available from Univar Ltd, Lakeside, Cheadle Royal Business Park, Cheadle, Cheshire, SK8 3GR).

The different UV blocking agents have different absorption spectra and different solubility in the different adhesives available for the layers 41 and 45. There are numerous combinations of UV blocking agent and adhesive available. The UV blocking agent will be chosen to have a sufficient degree of solubility in the adhesive chosen and, subject to cost constraints, to provide the best possible absorption spectrum to provide maximum UV protection. In general the UV blocking agents should show absorption at wavelengths in the near-UV (410-390 nm region), as well as giving very good absorption at shorter wavelengths (eg 370-340 nm). This may be tested by UV life testing experiments. If the absorption edge is too far into the visible part of the spectrum, the material cuts off blue light and appears yellow which is clearly not advantageous as it gives a colour cast to the image displayed on the display device 24. Such a UV blocking agent may also adversely affect the UV cure of the adhesive. The UV blocking agents may be a mixture of substances.

The UV blocking agent in the layers 41 and 45 may be the sole means of providing UV protection, although this is not essential and additional means for providing UV protection may be incorporated. For example the surface treatment 42 may have UV absorption properties as described above. Similarly a coating providing UV protection could be provided to a surface of a substrate 11 or 12 of a cell 10, preferably the front substrate 11 of the front cell 10B. Providing additional UV protection in this way enhances but does not replace the UV protection provided by the UV blocking agent in the layers 41 and 45.

FIG. 11 shows the absorption spectra of some possible UV blocking agents in the case that the adhesive is Epotek 310.

The UV blocking agent can be dissolved in the adhesive of the layers 41 and 45 at various concentrations in the adhesive to give different degrees of UV protection. For example, FIG. 12 shows the absorption spectra for the UV blocking agent benzophonone-2 at concentrations of 1% and 5% in the case that the adhesive is Slink 833. This illustrates that at the higher concentration of 5% the spectral long wavelength edge moves to a longer wavelength thus giving better UV protection.

Alternatively, the degree of UV protection can be varied by changing the thickness of the layers 41 and 45 in which the UV blocking agent is contained. The thickness of the layers 41 and 45 of adhesive governs the absorption of the UV light according to Beer's Law. For a given concentration of the UV blocking agent, the absorption of UV light increases as the thickness of the layers 41 and 45 of adhesive increases. Advantageously, the thickness of the layers 41 and 45 of adhesive is in the range from 20 μm to 80 μm, for example 50 μm.

The thickness of the layers 41 and 45 of adhesive may be controlled by dispersing spacers in the adhesive with the result that the spacers space the protective sheet 40 from the substrate 11 of the blue cell 10B. A variety of types of spacer are known for use in a display device and may be applied. For example the spacers may be spherical (although this is not essential) and may be made of a polymer. One type of spacer which is possible is a 50 μm diameter spherical spacer available from Sekisui (Sekisui Chemical GmbH, Cantadorstr. 3, D-40211, Dusseldorf, Germany), however other diameter spacers are also available. Spacers may be dispersed in the adhesive prior to use, this requiring mixing to prevent settling of the spacers and degassing to prevent the formation of bubbles.

In the example of FIG. 10, a contribution to the UV protection is provided by the UV blocking agent in each of the layers 41 and 45 (some of which may contain different amounts of UV blocking agent or none at all). So providing UV blocking agent in plural layers provides the advantage of increasing the total UV protection available.

Of course, the adhesive of the layers 41 and 45 can also contain a further additive besides the UV blocking agent. One possible further additive is a dye to change or improve the colour of the cholesteric display. For example the dye may be a red dye to improve the colour of a red display, or may be a yellow dye to reduce the blue colour typical in a cholesteric display.

By way of example an actual display device 24 has been made as follows.

A cell 10 was made with a liquid crystal layer 19 of cholesteric liquid crystal (BL118) injected between substrates 11 and 12 made of glass. A protective sheet 40 made of glass of thickness 0.7 mm with an anti-reflection coating 42 (obtained from Zytronix) was adhered to the substrate 11 of the cell by a layer 41 of Slink 2395 adhesive containing 5% benzophenone-2 as a UV blocking agent. The adhesive of the layer 41 was cured using low power UV lamp for 20 mins (UVA power 20-40 mW/cm²).

The display device 24 thus prepared and a comparative example identical except for the absence of the protective sheet 40 and layer 41 of adhesive were compared by irradiating them by a Dr Honle Suntest lamp for 200 hrs (this lamp emits approx 7× sunlight, 520 mW/cm²). Both display devices were then tested for change in colour and the results (Change of colour in DE) are shown in Table 1.

TABLE 1

| | Exposure time (hrs) | | |
|---|---|---|---|
| % benzophenone 2 | 0 | 23 | 70 |
| 0% - comparative example | 0 | 5.4 | 17.3 |
| 1% - display device 24 | 0 | 1.8 | 2.1 |
| 5% - display device 24 | 0 | 0.9 | 1.2 |

Minimal colour change is desired. As can be seen from Table 1, the display device 24 with UV protection in the layer 41 of adhesive showed much less colour change.

1. A cholesteric liquid crystal display device, comprising:
at least one cell comprising two substrates containing therebetween a layer of cholesteric liquid crystal material; and
a protective sheet or a stack of plural protective sheets, being adhered to the substrate at the front of the at least one cell by a layer of adhesive and, in the case of a stack of plural protective sheets, being adhered to each other by a layer of adhesive between each pair of adjacent protective sheets in the stack,
wherein
the adhesive is or an adhesive curable by light having a wavelength of at least 390 nm, and
the adhesive contains a UV blocking agent having a property of reducing the transmission of ultra-violet light through the adhesive.

2. A cholesteric liquid crystal display device according to claim 1, wherein the adhesive contains a further additive in addition to the UV blocking agent.

3. A cholesteric liquid crystal display device according to claim 2, wherein the further additive is a dye.

4. (canceled)

5. A cholesteric liquid crystal display device according to claim 1, wherein the or each protective sheet is made of glass.

6. A cholesteric liquid crystal display device according to claim 5, wherein the glass is one of soda lime glass or borosilicate glass.

7. A cholesteric liquid crystal display device according to claim 5, wherein the glass is heat-tempered glass.

8. A cholesteric liquid crystal display device according to claim 1, wherein the or each protective sheet is made of plastic.

9. A cholesteric liquid crystal display device according to claim 8, wherein the protective sheet or the stack of plural protective sheets has an outer coating which is harder than the plastic.

10. A cholesteric liquid crystal display device according to claim 1, wherein spacers are dispersed in the or each layer of adhesive.

11. A cholesteric liquid crystal display device according to claim 1, wherein the at least one cell comprises a stack of cells.

12. A cholesteric liquid crystal display device according to claim 1, wherein the substrates are made of glass.

13. A cholesteric liquid crystal display device according to claim 1, wherein the or each protective sheet has thickness of at most 2 mm.

14. A cholesteric liquid crystal display device according to claim 1, wherein the or each protective sheet has thickness of at most 1 mm.

15. A cholesteric liquid crystal display device according to claim 1, wherein the or each layer of adhesive has a thickness of at least 20 μm.

16. A cholesteric liquid crystal display device according to claim 1, wherein the or each layer of adhesive has a thickness of at most 80 μm.

17. A cholesteric liquid crystal display device according to claim 1, wherein the front surface of the protective sheet or the stack of plural protective sheets has a surface treatment thereon providing an anti-reflection property, an anti-glare property, a UV blocking property or any combination thereof.

18. A cholesteric liquid crystal display device according to claim 1, comprising a single adhesive sheet.

19. A cholesteric liquid crystal display device according to claim 1, comprising a stack of plural protective sheets.
